(19) United States
(12) Patent Application Publication
(10) Pub. No.: US 2025/0138460 A1
(43) Pub. Date: May 1, 2025

(54) PRINT CONTROL DEVICE, PRINT CONTROL SYSTEM, AND COMPUTER-READABLE MEDIUM STORING PRINT CONTROL PROGRAM

(71) Applicant: Konica Minolta, Inc., Tokyo (JP)

(72) Inventor: Munetoshi Eguchi, Tokyo (JP)

(73) Assignee: Konica Minolta, Inc., Tokyo (JP)

(21) Appl. No.: 18/926,230

(22) Filed: Oct. 24, 2024

(30) Foreign Application Priority Data
Oct. 30, 2023 (JP) 2023-185199

(51) Int. Cl. G03G 15/00; B41J 2/21; B41J 15/04

(52) U.S. Cl. CPC G03G 15/5012; B41J 2/2117; B41J 15/04; G03G 15/55; G03G 15/652

(57) ABSTRACT

A print control device includes a controller that causes a roll printing machine to print a color adjustment chart. The controller, upon reception of a first print instruction to print a first color adjustment chart, temporarily stores the received first color adjustment chart and suspends printing.

### CROSS REFERENCE TO RELATED APPLICATIONS

This application claims foreign priority to Japanese Patent Application No. 2023-185199, filed Oct. 30, 2023, the disclosure of which is incorporated herein by reference.

### BACKGROUND OF THE INVENTION

### Technical Field

The present invention relates to a print control device, a print control system, and a print control program, and for example, to a print control device that causes a roll printing machine to perform printing.

### Description of Related Art

When the color of a printed product is reproduced by a printing machine, color management is automatically performed customized to the reproducibility specific to the printing machine. On the other hand, when the user wants to strictly match the printed color with a color sample, the reproducibility of the automatically converted color may not match the user's desire. As means for solving this problem, the printing machine has a function for special colors and alternative colors. When reproducing special colors, YMCK tones are specified and the printing machine performs printing with the amount of toners or the amount of inks that match the specified tones. However, as the color reproducibility varies depending on the printing machine, the printed color does not match the desired color even if the user specifies the tones. When the printed color does not match the desired color, the user performs color adjustment using a color management application. The color management application can cause the printing machine to print a color sample for color adjustment (color adjustment chart). Here, the color adjustment chart is a two dimensional array of a plurality of color patches whose colors are shifted from one another with a special color as a center value. In response to a print instruction from the application, a controller internally generates a print image (color adjustment chart) and causes the printing machine to immediately perform printing. Then, the user selects a color patch of an appropriate color.

For example, Japanese Unexamined Patent Publication No. 2012-70298 discloses a color selection support apparatus and an image processing apparatus that, when a user gives a print instruction, generate a color adjustment chart and cause a printing machine to print the generated color adjustment chart.

### SUMMARY OF THE INVENTION

### Problems to be Solved by the Invention

A roll printing machine requires a predetermined braking distance in order to stabilize and safely stop the flutter of paper before and after printing. Due to the braking distance, unprinted sheets, i.e., waste sheets, occur for each print job. For example, even when the color adjustment chart is of the A4 size (about 0. 2 m), waste sheets corresponding to the braking distance (e.g., about 7 m) are generated. In addition, when handling a plurality of special colors, it is necessary to output color adjustment charts for a plurality of colors. In printing of a conventional color adjustment chart, printing is performed for each print instruction of a color adjustment chart, and therefore, there is a problem in that waste sheets occur each time a color adjustment chart is printed.

The present invention has been made in view of the above-described problem, and an object of the present invention is to provide a print control device, a print control system, and a non-transitory computer-readable recording medium storing a print control program, which are capable of reducing the generation of waste sheets.

### Means for Solving the Problem

To achieve at least the above-mentioned object, a print control device reflecting one aspect of the present invention includes a controller that causes a roll printing machine to print a color adjustment chart. The controller, upon reception of a first print instruction to print a first color adjustment chart, temporarily stores the received first color adjustment chart and suspends printing.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an overall configuration diagram of a roll printing machine print system according to a first embodiment of the present invention;

FIG. 2 is a flowchart for explaining the operation of the roll printing machine print system according to the first embodiment of the present invention:

FIG. 3 is a flowchart for explaining the operation of a roll printing machine print system according to a second embodiment of the present invention;

FIG. 4 is a diagram illustrating a printing result by a roll printing machine according to the second embodiment of the present invention;

FIG. 5 is a flowchart for explaining the operation of a roll printing machine print system according to a third embodiment of the present invention; and

FIG. 6 is an overall configuration diagram of a roll printing machine print system that is a comparative example of the present invention.

### DETAILED DESCRIPTION

Hereinbelow, one or more embodiments of the present invention will be described in detail with reference to the drawings. However, the scope of the invention is not limited to the disclosed embodiments. It should be noted that the drawings are merely schematic to the extent that the present invention can be fully understood. Therefore, the present invention is not limited to only the examples illustrated in the drawings. In addition, in the drawings, common constituent elements and similar constituent elements are denoted by the same reference signs, and duplicated description thereof is omitted.

A print control device of an embodiment according to the present invention includes a controller that causes a roll printing machine to print a color adjustment chart. The controller, upon reception of a first print instruction to print a first color adjustment chart, temporarily stores the received color adjustment chart and suspends printing.

### First Embodiment

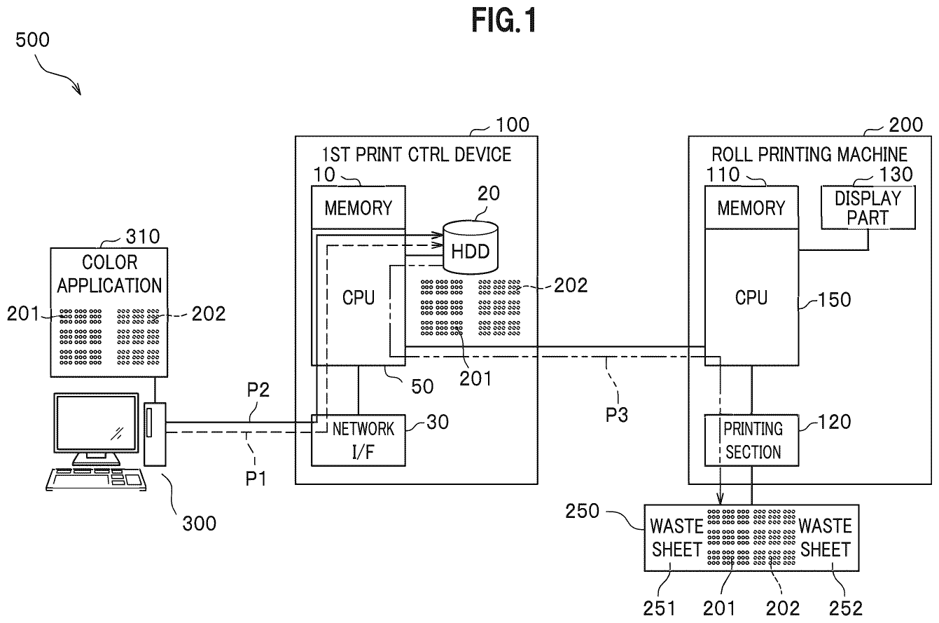

FIG. 1 is an overall configuration diagram of a roll printing machine print system according to a first embodiment of the present invention.

In a roll printing machine print system 500, a first print control device 100, a roll printing machine 200, and a second print control device 300 are communicably connected.

The second print control device 300 is a personal computer (PC) in which a color application 310 is installed. Note that the first print control device 100 and the second print control device 300 are connected via a network such as a wired local area network (LAN) or a wireless LAN. The color application 310 of the present embodiment generates a plurality of color adjustment charts (first color adjustment chart 201 and second color adjustment chart 202). First, the second print control device 300 outputs a first print instruction P1 (dashed line) for printing the first color adjustment chart 201 to the first print control device 100. Next, the second print control device 300 outputs a second print instruction P2 (solid line) for printing the second color adjustment chart 202 to the first print control device 100.

The first color adjustment chart 201 and the second color adjustment chart 202 are each obtained by arranging a plurality of color patches in a two dimensional array while shifting the color of each color patch around a special color (specific color). The plurality of color patches are obtained by, for example, shifting the YMCK tones of the special color or shifting the hue, saturation, and brightness of the special color. A typical special color is, for example, a corporate color.

The first print control device 100 outputs a third print instruction P3 (long dashed double-short dashed line) to the roll printing machine 200 based on the first print instruction P1 and the second print instruction P2. The roll printing machine 200 prints, using toners or inks, a print image based on the third print instruction P3 on roll paper 250.

The first print control device 100 includes a volatile storage section 10, a non-volatile storage section 20, a network I/F 30, and a controller 50. The volatile storage section 10 is a random access memory (RAM) and is used as a working memory. The non-volatile storage section 20 is a hard disk drive (HDD), a solid state disk (SSD), or the like. The non-volatile storage section 20 temporarily stores the first color adjustment chart 201 and the second color adjustment chart 202. The first color adjustment chart 201 and the second color adjustment chart 202 are received from the second print control device 300 as print instructions (first print instruction P1 and second print instruction P2). The network I/F 30 receives the first print instruction P1 and the second print instruction P2 from the second print Control device 300 via the network.

The controller 50 is a computer including a central processing unit (CPU) and an image generation device, which are not illustrated. The CPU controls each component by executing a print control program stored in the non-volatile storage section 20. The image generation device (not illustrated) generates and modifies a print image based on instructions from the CPU.

Specifically, the controller 50 temporarily stores the first color adjustment chart 201 included in the first print instruction P1 into the non-volatile storage section 20. The controller 50 also temporarily stores the second color adjustment chart 202 included in the second print instruction P2 into the non-volatile storage section 20. With this, the control of causing the roll printing machine to perform printing is on hold. Then, the controller 50 transmits the third print instruction P3 for collectively printing the first color adjustment chart 201 and the second color adjustment chart 202 temporarily stored in the non-volatile storage section 20 to the roll printing machine 200. As a result, a plurality of color adjustment charts (the first color adjustment chart 201 and the second color adjustment chart 202) are printed as one single job by the roll printing machine 200.

The roll printing machine 200 includes a volatile storage section 110, a printing section 120, a display part 130, and a controller 150. The volatile storage section 110 is a RAM and is used as a working memory. The printing section 120 is a mechanical device that prints on the roll paper 250 with toners or inks. The printing section 120 is configured to produce a printed image on the roll paper 250 while rotating the bobbin of the roll paper 250 to unwind a portion thereof including the printed image and preceding and succeeding portions of the printed image. Due to this, waste sheets 251 and 252 are generated before and after printing by the roll printing machine 200. The display part 130 is a liquid crystal display panel and displays a printing state, an error, and the like. The controller 150 is a CPU and controls each component.

When the roll printing machine 200 executes the third print instruction P3, a waste sheet 251 for stabilizing the flutter of the roll paper 250 is generated at the start of printing. When the flutter of the roll paper 250 has stabilized, the roll printing machine 200 prints the first color adjustment chart 201 on the roll paper 250. After printing, the roll printing machine 200 immediately prints the second color adjustment chart 202 on the roll paper 250. When finishing printing, a waste sheet 252 corresponding to the braking distance for safely stopping the roll paper 250 is generated.

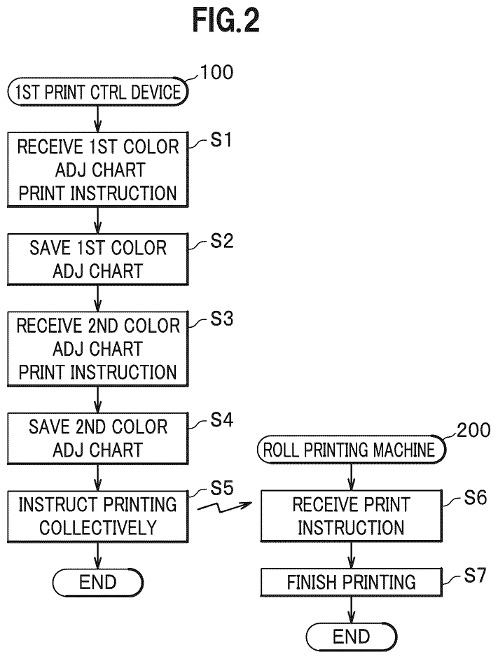

FIG. 2 is a flowchart for explaining the operation of the roll printing machine print system of the first embodiment according to the present invention.

In step S1, the controller 50 (FIG. 1) of the first print control device 100 receives a print instruction (first print instruction P1 (FIG. 1)) for causing the roll printing machine 200 to print the first color adjustment chart 201 from the second print control device 300. After the processing of step S1, in step S2, the controller 50 stores the received first color adjustment chart 201 in the non-volatile storage section 20 (FIG. 1). After the processing of step S2, in step S3, the controller 50 receives a print instruction (second print instruction P2 (FIG. 1)) for causing the roll printing machine 200 to print the second color adjustment chart 202 from the second print control device 300.

After the processing of step S3, in step S4, the controller 50 stores the received second color adjustment chart 202 in the non-volatile storage section 20. After the processing of step S4, in step S5, the controller 50 transmits, to the roll printing machine 200, a print instruction (third print instruction P3) to collectively print the plurality of stored (temporarily stored) color adjustment charts. The third print instruction P3 is for collectively printing the first color adjustment chart 201 and the second color adjustment chart 202. With this, the processing of the first print control device 100 is finished. The roll printing machine 200, in step S6, receives the print instruction (third print instruction P3), and in step S7, completes printing. With this, the processing of the roll printing machine 200 is finished.

As described above, according to the roll printing machine print system 500 of the present embodiment, a plurality of color adjustment charts temporarily stored in the non-volatile storage section 20 are collectively printed. That is, the plurality of color adjustment charts (the first color adjustment chart 201 and the second color adjustment chart 202) are collectively printed as one single job. Therefore, waste sheets 251 and 252 before and after printing are generated on the roll paper 250. However, no waste sheet is generated between the first color adjustment chart 201 and the second color adjustment chart 202.

### Second Embodiment

In the above-described first embodiment, the controller 50 collectively prints the plurality of color adjustment charts (the first color adjustment chart 201 and the second color adjustment chart 202). In the present embodiment, the controller 50 causes printing of a print image other than color adjustment charts and a color adjustment chart collectively.

FIG. 3 is a flowchart for explaining the operation of the roll printing machine print system according to the second embodiment of the present invention. Here, the configuration of the roll printing machine print system is the same as that of the first embodiment. However, they differ in that the print control program is different. In addition, it is assumed that there is no second print instruction P2 for printing the second color adjustment chart 202 and that a print job is stored in advance in the non-volatile storage section 20.

In step S11, a user sets a special color name to the second print control device 300. Here, the special color name means the name of a special color. A special color means the color of an ink that is formulated (toned) in advance for the purpose of expressing a color not reproducible with process colors. The special color is also referred to as a spot color or a specialized color, and is, for example, a corporate color.

After the processing of step S11, in step S12, the second print control device 300 transmits, to the first print control device 100, a print instruction (first print instruction P1 (FIG. 1)) for printing the first color adjustment chart 201 in which the special color is designated. After the processing of S12, in step S13, the controller 50 of the first print control device 100 receives the print instruction (first print instruction P1) for printing the first color adjustment chart 201 from the second print control device 300. After the processing of step S13, in step S14, the controller 50 stores the first color adjustment chart 201 in the non-volatile storage section 20 (FIG. 1). Furthermore, in step S14, the controller 50 assigns the special color name to the job name.

After the processing of step S14, in step S15, the controller 50 determines whether another saved job to which the same special color name has been assigned is present in the non-volatile storage section 20. When another saved job to which the same special color name has been assigned is not present (“No” at step S15), the controller 50 finishes the processing in order to standby until a next user instruction is given.

On the other hand, when another saved job with the same special color name is present (“Yes” at step S15), the controller 50 reads both the other saved job with the same special color name and the first color adjustment chart 201 from the non-volatile storage section 20. Further, in step S16, the controller 50 issues, to the roll printing machine 200, a print instruction (third print instruction P3 (FIG. 1)) for collectively printing the image of the other saved job with the same special color name and the first color adjustment chart 201, and finishes the processing. In step S17, the roll printing machine 200 receives the print instruction (third print instruction P3) from the first print control device 100. After the processing of step S17, in step S18, the roll printing machine 200 completes printing.

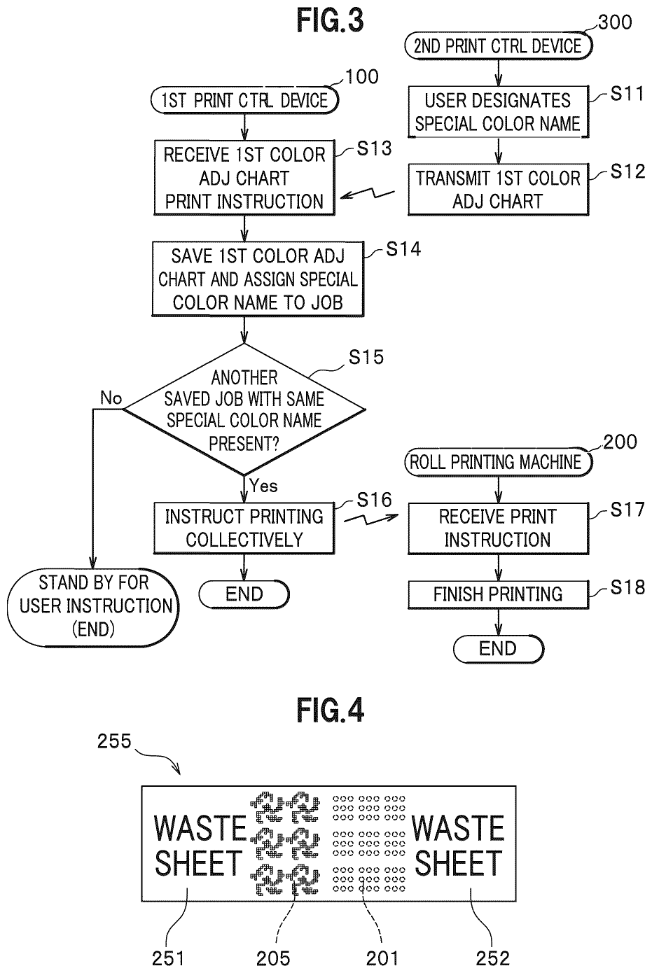

FIG. 4 is a diagram illustrating a printing result by the roll printing machine according to the second embodiment of the present invention.

When the roll printing machine 200 starts print processing, a waste sheet 251 is generated in the roll paper 255. After that, both the image 205 of the other saved job to which the same special color name has been assigned and the first color adjustment chart 201 are collectively printed. After that, a waste sheet 252 is generated due to the stop of printing.

The image 205 of the other saved job can be used for positioning and positional deviation adjustment when the specific image is continuously printed. That is, as the first color adjustment chart 201 and the image 205 are printed at the same time, the operator can perform color adjustment and positional deviation adjustment at the same time.

As described above, the first color adjustment chart 201 and the image 205 of the print job temporarily stored in the non-volatile storage section 20 of the present embodiment are collectively printed. Therefore, no waste sheet is generated in the roll paper 255 between the first color adjustment chart 201 and the image 205 of the print job. Note that even at this time, waste sheets 251 and 252 are generated before and after printing. However, the waste sheets which would be generated when the color adjustment and the positional deviation adjustment are performed at the same time is reduced.

Note that the second embodiment assumes that the print image of the other saved job with the same special color name includes the special color. Note further that, in the description of the second embodiment, the phrases “other saved job to which the same special color name has been assigned” and “other saved job with the same special color name” each cover cases where the name of the saved job includes the special color name in addition to a case where the name of the saved job is exactly the same as the special color name.

### Third Embodiment

In the second embodiment, the controller 50 collectively prints the first color adjustment chart 201 and the image 205 of the other saved job having the same special color name of the first color adjustment chart 201. In the present embodiment, the controller 50 collectively print the first color adjustment chart 201 and the image of a job (reserved previous job) different from the job to print the first color adjustment chart 201. A reserved previous job(s) may have been saved in the first print control device 100 (FIG. 1) before a job for printing the first color adjustment chart 201 occurs. In addition, settings other than color tone may have not been completed.

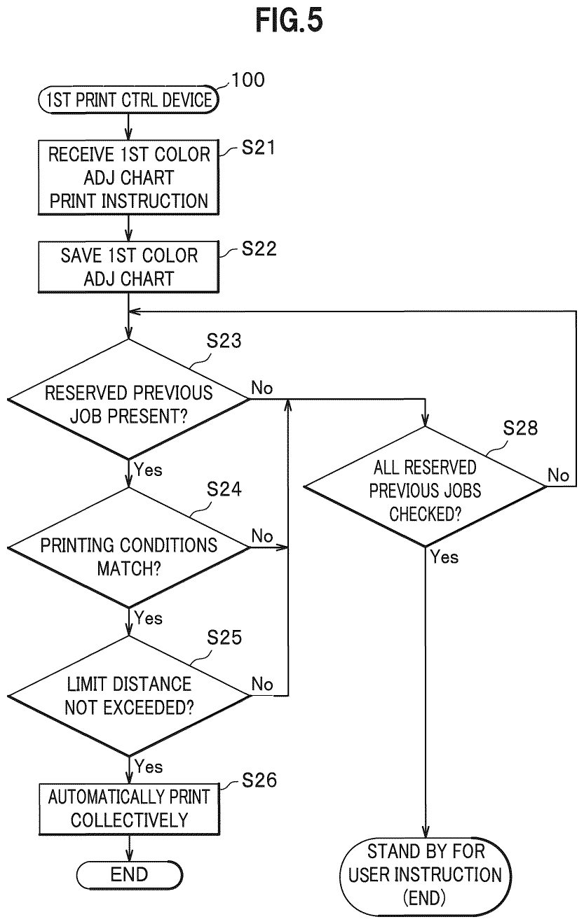

FIG. 5 is a flowchart for explaining the operation of the roll printing machine print system of the third embodiment according to the present invention. Here, the configuration of the roll printing machine print system is the same as that of the first embodiment. However, they differ in that the print control program is different. In addition, similarly to the second embodiment, it is assumed that there is no second print instruction P2 for printing the second color adjustment chart 202 and that a previous job(s) are stored in the non-volatile storage section 20 in advance.

In step S21, the controller 50 of the first print control device 100 (FIG. 1) receives a first print instruction P1 (FIG. 1) for printing the first color adjustment chart 201 from the second print control device 300. After the processing of step S21, in step S22, the controller 50 stores (temporarily stores) the received first color adjustment chart 201 in the non-volatile storage section 20. After the processing of step S22, in step S23, the controller 50 determines whether a reserved previous job is present. That is, in step S23, the controller 50 checks the non-volatile storage section 20 to determine whether a previous job for which printing has been suspended is present.

When a reserved previous job is present (“Yes” in step S23), in step S24, the controller 50 determines whether the printing conditions match between the temporarily stored first color adjustment chart 201 and the reserved previous job. Here, examples of the printing condition(s) include a paper type, a screen setting, the number of toner colors, and a continuous printing distance. The number of toner colors varies depending on, for example, the presence of a white toner in addition to the four colors of YMCK. When there is no white toner, the number of toner colors is 4. On the other hand, when there is a white toner, the number of toner colors is 5. In addition, the roll printing machine has a limitation on the distance through which printing can be continuously performed. The continuous printing distance means the limit distance through which continuous printing is possible.

When the printing conditions match (“Yes” in step S24), in step S25, the controller 50 determines whether the limit distance is exceeded. When a print instruction (third print instruction P3 (FIG. 1)) to collectively print the first color adjustment chart 201 and the reserved previous job is executed, an image condition (for example, a printing rate) changes. Therefore, the controller 50 confirms that the limit distance condition of the reserved previous job does not change.

If the limit distance is not exceeded (“Yes” in step S25), in step S26, the controller 50 automatically combine the first color adjustment chart 201 with the reserved previous job. In other words, the controller 50 incorporates the first color adjustment chart 201 into the reserved previous job. Specifically, the controller 50 arranges the first color adjustment chart 201 at the end of the reserved previous job. Furthermore, in step S26, the controller 50 instructs the roll printing machine 200 to print the reserved previous job, in which the first color adjustment chart 201 has been arranged at the end of the reserved previous job, and finishes the processing. As a result, the image of the reserved previous job and the first color adjustment chart 201 are collectively printed in this order as a single job.

On the other hand, when the determination result in step S23 is “No”, the determination result in step S24 is “No”, or the determination result in step S25 is “No”, the controller 50 executes the processing of step S28. In step S28, the controller 50 determines whether all the reserved previous jobs have been checked. If not all the reserved previous jobs have been checked (“No” in step S28), the controller 50 returns the processing to step S23, and determines whether another reserved previous job is present. On the other hand, when all the reserved previous jobs have been checked (“Yes” in step S28), the controller 50 enters into a stand-by state for waiting for a user instruction and finishes the processing.

As described above, according to the present embodiment, the first color adjustment chart 201 and a reserved previous job whose printing condition(s) (paper type, screen setting, number of toner colors, limit distance, and the like) match those of the first color adjustment chart 201 are collectively printed. Therefore, although waste sheets 251 and 252 before and after printing are generated in the roll paper 255 (FIG. 4), no waste sheet is generated between the first color adjustment chart 201 and the image 205 of the previous job.

### Comparative Example

In the first embodiment, the controller 50 temporarily stores a plurality of color adjustment charts in the non-volatile storage section 20 and causes the roll printing machine 200 to print them collectively as a single job. In the present comparative example, the controller 50 causes the roll printing machine 200 to print each of the plurality of color adjustment charts (the first color adjustment chart 201 and the second color adjustment chart 202) as an individual job.

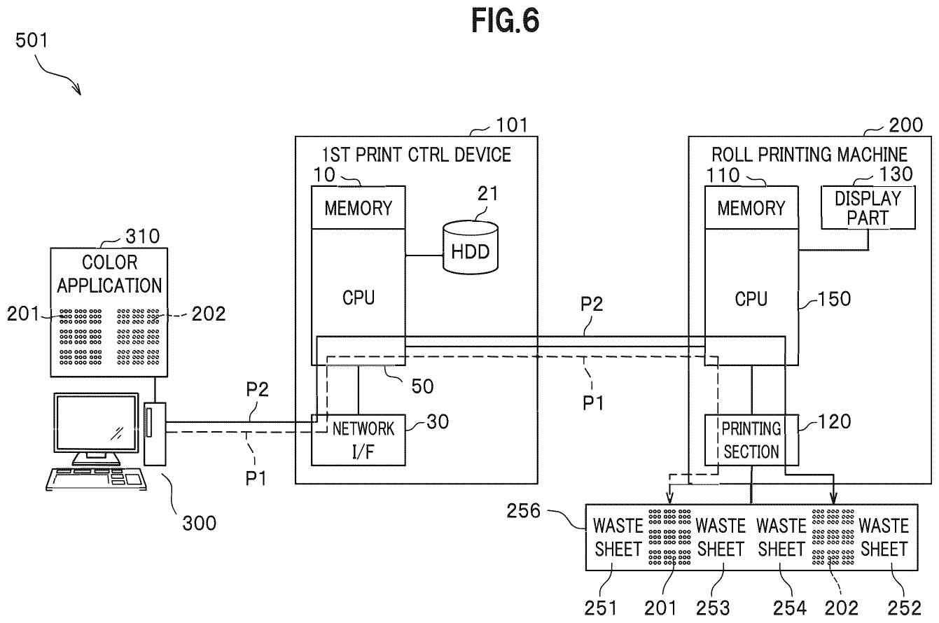

FIG. 6 is a configuration diagram of a roll printing machine print system functioning as a comparative example of the present invention.

The roll printing machine print system 501 includes the roll printing machine 200 and the second print control device 300, similarly to the roll printing machine print system 500 (FIG. 1) of the first embodiment. However, the roll printing machine print system 501 differs from the roll printing machine print system 500 in that a first print control device 101 is provided instead of the first print control device 100.

The first print control device 101 includes a volatile storage section 10, a non-volatile storage section 21, a network I/F 30, and a controller 50, similarly to the first print control device 100 of the first embodiment. However, the non-volatile storage section 21 differs from the non-volatile storage section 20 of the first embodiment in that the non-volatile storage section 21 does not temporarily store a plurality of color adjustment charts (the first color adjustment chart 201 and the second color adjustment chart 202).

As in the first embodiment, the second print control device 300 generates a plurality of color adjustment charts (the first color adjustment chart 201 and the second color adjustment chart 202) using the color application 310. The first print instruction P1 (dashed line) for printing the first color adjustment chart 201 is transmitted to the roll printing machine 200 via the first print control device 101. Thus, the roll printing machine 200 generates a waste sheet 251 and then prints the first color adjustment chart 201. Furthermore, the roll printing machine 200 generates a waste sheet 253 in order to safely stop the roll paper 256.

Next, the second print instruction P2 (solid line) for printing the second color adjustment chart 202 is transmitted to the roll printing machine 200 via the first print control device 101. According to this, the roll printing machine 200 generates a waste sheet 254 and then prints the second color adjustment chart 202. Furthermore, the roll printing machine 200 generates a waste sheet 252 in order to safely stop the roll paper 256.

As described above, according to the roll printing machine print system 501 of the comparative example, the plurality of color adjustment charts (the first color adjustment chart 201 and the second color adjustment chart 202) are individually printed. Therefore, on the roll paper 256, in addition to the waste sheets 251 and 252 generated before and after printing, the waste sheets 253 and 254 are generated between the first color adjustment chart 201 and the second color adjustment chart 202.

### Modification Example

The present invention is not limited to the above-described embodiments, and can be modified without departing from the gist of the present invention. The modification examples includes (a) and (b) listed below.
(a) In the first embodiment, two color adjustment charts, the first color adjustment chart 201 and the second color adjustment chart 202, are printed, but three or more color adjustment charts may be printed.
(b) In the above embodiments, the first print control device 100 and the second print control device 300 are separated. In this regard, both of them may be integrated into a print control device. This print control device causes the roll printing machine 200 to perform printing using a print instruction to collectively print the first color adjustment chart 201 and the second color adjustment chart 202.

Although embodiments of the present invention have been described and illustrated in detail, the disclosed embodiments are made for purposes of illustration and example only and not limitation. The scope of the present invention should be interpreted by terms of the appended claims.

What is claimed is:

1. A print control device comprising:
a controller that causes a roll printing machine to print a color adjustment chart,
wherein the controller, upon reception of a first print instruction to print a first color adjustment chart, temporarily stores the received first color adjustment chart and suspends printing.

2. The print Control device according to claim 1,
wherein the controller, upon reception of a second print instruction to print a second color adjustment chart different from the first color adjustment chart, causes the roll printing machine to collectively print the temporarily stored first color adjustment chart and the second color adjustment chart.

3. The print Control device according to claim 2,
wherein the roll printing machine, upon reception of a print instruction, which is any one of a third print instruction to collectively print the first color adjustment chart and the second color adjustment chart, the first print instruction, and the second print instruction, produces a printed image of the print instruction on roll paper while rotating a bobbin of the roll paper to unwind a portion thereof including the printed image and preceding and succeeding portions of the printed image.

4. The print Control device according to claim 2,
wherein the controller instructs the roll printing machine to collectively print the first color adjustment chart and the second color adjustment chart, which in turn causes the roll printing machine to produce a printed image of the first color adjustment chart and the second color adjustment chart on roll paper while rotating a bobbin of the roll paper to unwind a portion thereof including the printed image and preceding and succeeding portions of the printed image.

5. The print Control device according to claim 1,
wherein the first color adjustment chart is composed of a plurality of color patches whose colors are shifted with respect to a special color.

6. The print Control device according to claim 5,
wherein the controller causes the roll printing machine to collectively print the temporarily stored first color adjustment chart and an image of a job whose name includes a name of the special color.

7. The print Control device according to claim 5,
wherein the controller arranges the temporarily stored first color adjustment chart at an end of a previous job and causes the roll printing machine to print the previous job.

8. The print Control device according to claim 5,
wherein the controller incorporates the temporarily stored first color adjustment chart into a job with a printing condition matching a printing condition of the temporarily stored first color adjustment chart and causes the roll printing machine to print the job.

9. The print Control device according to claim 8,
wherein the printing condition include a paper type, a screen setting, presence of a white toner, and a continuous printing distance.

10. A roll printing machine print system comprising:
a roll printing machine; and
a print control device that causes the roll printing machine to print a color adjustment chart,
wherein the print control device, upon reception of a first print instruction to print a first color adjustment chart, temporarily stores the received color adjustment chart and suspends printing, and
wherein the roll printing machine, upon reception of a print instruction to print the first color adjustment chart, rotates a bobbin of roll paper.

11. A non-transitory computer-readable medium storing a print control program to be executed by a computer of a print control device that causes a roll printing machine to print a color adjustment chart, the print control program causing the computer to perform steps comprising;
upon reception of a first print instruction to print a first color adjustment chart, temporarily storing the received color adjustment chart and suspending printing.
